(19) United States
(12) Patent Application Publication
(10) Pub. No.: US 2025/0063574 A1
(43) Pub. Date: Feb. 20, 2025

(54) MAC CE SIGNALING FOR SUPPORTING BOTH JOINT DL/UL TCI AND SEPARATE DL/UL TCI OPERATIONS

(71) Applicant: Telefonaktiebolaget LM Ericsson (publ), Stockholm (SE)

(72) Inventors: Helka-Liina Määttänen, Espoo (FI); Siva Muruganathan, Stittsville (CA)

(21) Appl. No.: 18/711,963

(22) PCT Filed: Nov. 28, 2022
(86) PCT No.: PCT/IB2022/061494

§ 371 Date: May 21, 2024

Related U.S. Application Data
(60) Provisional application No. 63/283,391, filed on Nov. 26, 2021.

(51) Int. Cl. H04W 72/231; H04W 76/20; H04W 80/02

(52) U.S. Cl. CPC H04W 72/231; H04W 76/20; H04W 80/02

(57) ABSTRACT

Systems and methods are disclosed for signaling for supporting joint and separate downlink/uplink Transmission Configuration Indication (TCI) operations. In one embodiment, a method performed by a User Equipment (UE) comprises receiving a Medium Access Control (MAC) Control Element (CE) message from a network node and receiving a Downlink Control Information (DCI) from the network node comprising a TCI field set to one of a plurality of TCI field codepoints. The MAC CE maps TCI states to at least some of the TCI field codepoints. The MAC CE comprises a first field that indicates whether a first TCI state indicated by the MAC CE that is mapped to a first TCI field codepoint in the DCI is a downlink (DL) TCI state or an uplink (UL) TCI state and information that indicates whether a DL TCI state, UL TCI state, or both are indicated for the first TCI field codepoint.

### RELATED APPLICATIONS

This application claims the benefit of provisional patent application Ser. No. 63/283,391, filed Nov. 26, 2021, the disclosure of which is hereby incorporated herein by reference in its entirety.

### TECHNICAL FIELD

The present disclosure relates to a cellular communications system such as, e.g., a Third Generation Partnership Project (3GPP) system and, more particularly, to Transmission Configuration Indication (TCI) state activation/deactivation in a cellular communications system.

### BACKGROUND

### QCL and TCI States

In Third Generation Partnership Project (3GPP) New Radio (NR), several signals can be transmitted from different antenna ports of a same base station. These signals can have the same large-scale properties such as Doppler shift/spread, average delay spread, or average delay. These antenna ports are then said to be Quasi Co-Located (QCL).

If the User Equipment (UE) knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a Channel State Information (CSI) Reference Signal (CSI-RS) for Tracking Reference Signal (TRS) and the Physical Downlink Shared Channel (PDSCH) Demodulation Reference Signal (DMRS). When the UE receives the PDSCH DMRS, it can use the measurements already made on the TRS to assist the DMRS reception.

Information about what assumptions can be made regarding QCL is signaled to the UE from the network. In NR, four types of QCL relations between a transmitted source Reference Signal (RS) and transmitted target RS are defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL Type D was introduced to facilitate beam management with analog beamforming and is known as spatial QCL. There is currently no strict definition of spatial QCL, but the understanding is that if two transmitted antenna ports are spatially QCL, the UE can use the same receive (RX) beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal. Note that, for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a TRS for time/frequency offset estimation. To be able to use any QCL reference, the UE would have to receive it with a sufficiently good Signal to Interference plus Noise Ratio (SINR). In many cases, this means that the TRS must be transmitted in a suitable beam to a certain UE.

To introduce dynamics in beam and transmission/reception point (TRP) selection, the UE can be configured through Radio Resource Control (RRC) signaling with up to 128 Transmission Configuration Indicator (TCI) states. The TCI state information element is shown in FIG. 1 (extracted from 3GPP TS 38.331).

Each TCI state contains QCL information related to one or two RSs. For example, a TCI state may contain CSI-RS1 associated with QCL Type A and CSI-RS2 associated with QCL Type D. If a third RS, e.g., the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for Physical Downlink Control Channel (PDCCH). Each TCI state contains a pointer, known as TCI State ID, which points to the TCI state. The network then activates, via Medium Access Control (MAC) Control Element (CE), one TCI state for PDCCH (i.e., provides a TCI for PDCCH) and up to eight TCI states for PDSCH. The number of active TCI states the UE support is a UE capability, but the maximum is currently 8.

Assume a UE has four (4) activated TCI states (from a list of totally sixty-four (64) configured TCI states). Hence, sixty (60) TCI states are inactive for this particular UE, and the UE needs not be prepared to have large scale parameters estimated for those inactive TCI states. But the UE continuously tracks and updates the large-scale parameters for the RSs in the four active TCI states. When scheduling a PDSCH to a UE, the Downlink Control Information (DCI) contains a pointer to one activated TCI state. The UE then knows which large scale parameter estimate to use when performing PDSCH DMRS channel estimation and thus PDSCH demodulation.

As long as the UE can use any of the currently activated TCI states, it is sufficient to use DCI signaling. However, at some point in time, none of the source RSs in the currently activated TCI states can be received by the UE, i.e., when the UE moves out of the beams in which the source RSs in the activated TCI states are transmitted. When this happens (or actually before this happens), the NR base station (gNB) would have to activate new TCI states. Typically, since the number of activated TCI states is fixed, the gNB would also have to deactivate one or more of the currently activated TCI states.

The two-step procedure related to TCI state update is depicted in FIG. 2. The selected TCI state is selected from the activated set of TCI states using DCI, and the set of activated TCI states is updated using MAC CE.

### TCI States Activation/Deactivation for UE-Specific PDSCH Via MAC CE

Now, details of the MAC CE signaling that is used to activate/deactivate TCI states for UE specific PDSCH are provided. The structure of the MAC CE for activating/deactivating TCI states for UE specific PDSCH is given in FIG. 3. FIG. 3 illustrates TCI States Activation/Deactivation for UE-specific PDSCH MAC CE (Extracted from Figure 6.1.3.14-1 of 3GPP TS 38.321).

As shown in FIG. 3, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part (BWP) for which the MAC CE applies. The BWP ID is given by the higher layer parameter BWP-Id as specified in 3GPP TS 38.331 (see, e.g., V16.6.0). The length of the BWP ID field is 2 bits since a UE can be configured with up to 4 BWPs for DL;
A variable number of fields Tᵢ: If the UE is configured with a TCI state with TCI State ID i, then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to a codepoint of the DCI Transmission Configuration Indication field, as specified in 3GPP TS 38.214 (see, e.g., V16.7.0)/TS 38.321 (see, e.g., V16.6.0). The Tᵢ field is set to “0” to indicate that the TCI state with TCI State ID i shall be deactivated and is not mapped to any codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC Protocol Data Unit (PDU) subheader with logical channel ID (LCID) as specified in Table 6.2.1-1 of 3GPP TS 38.321. The MAC CE for Activation/Deactivation of TCI States for UE-specific PDSCH has variable size.

### TCI State Indication for UE-Specific PDSCH Via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 4. The DCI gives a pointer into the ordered list of activated TCI states. DCI code point 0 indicates the first TCI state index in the list of TCI states, DCI code point 1 indicates the second TCI state index in the list, and so on.

### Rel-17 TCI State Framework

In 3GPP NR Rel-17, a new unified TCI state framework is being specified, which aims to streamline the indication of transmit/receive spatial filter (and other QCL properties) to the UE by letting a single TCI state indicate QCL properties for multiple different downlink (DL) and/or uplink (UL) signals/channels.

In meeting RAN1 #103-e, it was agreed that the new unified TCI state framework should include a three stage TCI state indication (in a similar way as was described above for PDSCH) for all or a subset of all DL and/or UL channels/signals. In the first stage, RRC is used to configure a pool of TCI states. In the second stage, one or more of the RRC configured TCI states are activated via MAC CE signaling and associated to different TCI field codepoints in DCI format 1_1 and 1_2. Finally, in the third stage, DCI signaling is used to select one of the TCI states (or two TCI states in case separate TCI states are used for DL channels/signals and UL channels/signals) that was activated via MAC CE.

In RAN1 #103-e meeting, it was agreed to support both joint beam indication (“Joint DL/UL TCI”) and separate DL/UL beam indication (“Separate DL/UL TCI”), as can be seen in the agreements below. For Joint DL/UL TCI, a single TCI state (which for example can be a DL TCI state or a Joint DL/UL TCI state) is used to determine a transmit/receive spatial filter for both DL signals/channels and UL signals/channels. For Separate DL/UL TCI, one TCI state (for example a DL TCI state) can be used to indicate a receive spatial filter for DL signals/channels and a separate TCI state (for example an UL TCI state) can be used to indicate a transmit spatial filter for UL signals/channels.

### Agreement

On beam indication signaling medium to support joint or separate DL/UL beam indication in Rel. 17 unified TCI framework:
   Support L1-based beam indication using at least UE-specific (unicast) DCI to indicate joint or separate DL/UL beam indication from the active TCI states
      The existing DCI formats 1_1 and 1_2 are reused for beam indication
   Support activation of one or more TCI states via MAC CE analogous to Rel. 15/16:

### Agreement

On Rel-17 unified TCI framework, to accommodate the case of separate beam indication for UL and DL:
   Utilize two separate TCI states, one for DL and one for UL.
   For the separate DL TCI:
      The source reference signal(s) in M TCIs provide QCL information at least for UE-dedicated reception on PDSCH and for UE-dedicated reception on all or subset of CORESETs in a CC
   For the separate UL TCI:
      The source reference signal(s) in N TCIs provide a reference for determining common UL TX spatial filter(s) at least for dynamic-grant/configured-grant based PUSCH, all or subset of dedicated PUCCH resources in a CC
      Optionally, this UL TX spatial filter can also apply to all SRS resources in resource set(s) configured for antenna switching/codebook-based/non-codebook-based UL transmissions
   FFS: Whether the UL TCI state is taken from a common/same or separate TCI state pool from DL TCI state

For “Joint DL/UL TCI” operation, one Joint TCI state can be activated per TCI codepoint of the DCI. One schematic example of how this may look is illustrated in FIG. 5. In case the indicated TCI codepoint is “3” in the DCI UE receives as DL assignment, the UE should apply “Joint TCI state 10” as common QCL source for both DL and UL signals/channels in this example.

In RAN1 #105-e meeting, the following agreement was reached:

### Agreement

For M=N=1, on Rel-17 unified TCI, for separate DL/UL TCI, one instance of beam indication using DCI formats 1_1/1_2 (with and without DL assignment) can be used as follows:
   One TCI field codepoint represents a pair of DL TCI state and UL TCI state. If the DCI indicates such a TCI field codepoint, the UE applies the corresponding DL TCI state and UL TCI state.
   One TCI field codepoint represents only a DL TCI state. If the DCI indicates such a TCI field codepoint, the UE applies the corresponding DL TCI state, and keeps the current UL TCI state.
   One TCI field codepoint represents only an UL TCI state. If the DCI indicates such a TCI field codepoint, the UE applies the corresponding UL TCI state, and keeps the current DL TCI state.
FFS: the cases of M or N>1

According to the above agreement, for “Separate DL/UL TCI”, up to two TCI states can be activated per TCI codepoint of the DCI, one for DL signals/channels (DL-only TCI state) and one for UL signals/channels (UL-only TCI state). One schematic example of how this may look is illustrated in FIG. 6. In case the TCI codepoint is “0”, the UE should apply “DL-only TCI state 3” as common QCL source for DL signals/channels, and not update the QCL source for UL signals channel. In case the TCI codepoint is “7”, the UE should apply “UL-only TCI state 57” as QCL source for UL signals/channels, and not update the QCL source for DL signals/channel. In case the TCI codepoint is “3”, the UE should apply “DL-only TCI state 10” as QCL source for DL signals/channels and apply “UL-only TCI state 12” as QCL source for UL signals/channels.

### SUMMARY

Systems and methods are disclosed for Medium Access Control (MAC) Control Element (CE) signaling for supporting both joint downlink/uplink Transmission Configuration Indication (TCI) and separate downlink/uplink TCI operations. In one embodiment, a method performed by a User Equipment (UE) for mapping TCI states to TCI field codepoints in a Downlink Control Information (DCI) comprises receiving a MAC CE message from a network node and receiving a DCI from the network node, the DCI comprising a TCI field set to one of a plurality of TCI field codepoints. The MAC CE maps TCI states to at least some of the plurality of TCI field codepoints, the MAC CE comprises a first field that indicates whether a first TCI state indicated by the MAC CE that is mapped to a first TCI field codepoint in the DCI is a downlink (DL) TCI state or an uplink (UL) TCI state, and the MAC CE comprises information that indicates whether a DL TCI state, UL TCI state, or both a DL TCI state and an UL TCI state are indicated for the first TCI field codepoint. In this manner, a low overhead approach to mapping TCI states to TCI field codepoints in a DCI is provided.

In one embodiment, the first field indicates that the first TCI state indicated by the MAC CE that is mapped to the first TCI field codepoint in the DCI is a DL TCI state. In one embodiment, the MAC CE further comprises a second field that indicates whether the MAC CE further indicates an UL TCI state mapped to the first TCI field codepoint in the DCI. In one embodiment, the information that indicates whether a DL TCI state, UL TCI state, or both a DL TCI state and an UL TCI state are indicated for the first TCI field codepoint comprises the first field and the second field.

In one embodiment, the MAC CE further comprises a second field that indicates whether the MAC CE further indicates whether one or two TCI states are indicated for the first TCI field codepoint in the DCI.

In one embodiment, the one of the plurality of TCI field codepoints to which the TCI field in the DCI is set is the first TCI field codepoint, and the method further comprises applying the DL TCI state mapped to the first codepoint of the TCI field of the DCI for DL signals and/or channels.

In one embodiment, the first field indicates that the first TCI state indicated by the MAC CE that is mapped to the first TCI field codepoint in the DCI is an UL TCI state. In one embodiment, the one of the plurality of TCI field codepoints to which the TCI field in the DCI is set is the first TCI field codepoint, and the method further comprises applying the UL TCI state mapped to the first codepoint of the TCI field of the DCI for UL signals and/or channels.

In one embodiment, the MAC CE is in accordance with a MAC CE format for activation of separate DL and UL TCI states.

Corresponding embodiments of a UE for mapping TCI states to TCI field codepoints in a DCI are also disclosed. In one embodiment, a UE for mapping TCI states to TCI field codepoints in a DCI is adapted to receive a MAC CE message from a network node and receive a DCI from the network node, the DCI comprising a TCI field set to one of a plurality of TCI field codepoints. The MAC CE maps TCI states to at least some of the plurality of TCI field codepoints, the MAC CE comprises a first field that indicates whether a first TCI state indicated by the MAC CE that is mapped to a first TCI field codepoint in the DCI is a DL TCI state or an UL TCI state, and the MAC CE comprises information that indicates whether a DL TCI state, UL TCI state, or both a DL TCI state and an UL TCI state are indicated for the first TCI field codepoint.

In one embodiment, a UE for mapping TCI states to TCI field codepoints in a DCI comprises one or more transmitters, one or more receivers, and processing circuitry associated with the one or more transmitters and the one or more receivers. The processing circuitry is configured to cause the UE to receive a MAC CE message from a network node and receive a DCI from the network node, the DCI comprising a TCI field set to one of a plurality of TCI field codepoints. The MAC CE maps TCI states to at least some of the plurality of TCI field codepoints, the MAC CE comprises a first field that indicates whether a first TCI state indicated by the MAC CE that is mapped to a first TCI field codepoint in the DCI is a DL TCI state or an UL TCI state, and the MAC CE comprises information that indicates whether a DL TCI state, UL TCI state, or both a DL TCI state and an UL TCI state are indicated for the first TCI field codepoint.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Transmission Configuration State Information (TCI) defined in 3^{rd} Generation Partnership Project (3GPP) Technical Specification (TS) 38.331;

FIG. 2 illustrates the two-step procedure related to TCI state update;

FIG. 3 illustrates TCI States Activation/Deactivation for User Equipment (UE)-specific Physical Downlink Shared Channel (PDSCH) Medium Access Control (MAC) Control Element (CE) (Extracted from Figure 6.1.3.14-1 of 3GPP TS 38.321);

FIG. 4 illustrates one example of a Downlink Control Information (DCI) TCI indication;

FIG. 5 illustrates one example of how joint TCI state can be activated per TCI codepoint of the DCI;

FIG. 6 illustrates one example of activation of up to two TCI states per TCI codepoint of the DCI for separate downlink (DL)/uplink (UL) TCI;

FIG. 7 illustrates a first MAC CE design in accordance with one embodiment of the present disclosure;

FIG. 8 illustrates the operation of a network node and a UE in accordance with at least some aspects of the embodiments described herein with respect to FIG. 7;

FIG. 9 illustrates another MAC CE design in accordance with an embodiment of the present disclosure;

FIG. 10 illustrates the operation of a network node and a UE in accordance with at least some aspects of the embodiments described herein with respect to FIG. 9;

FIG. 11 shows an example of a communication system in accordance with some embodiments;

FIG. 12 shows a UE in accordance with some embodiments;

FIG. 13 shows a network node in accordance with some embodiments;

FIG. 14 is a block diagram of a host, which may be an embodiment of the host of FIG. 11, in accordance with various aspects described herein;

FIG. 15 is a block diagram illustrating a virtualization environment in which functions implemented by some embodiments may be virtualized; and

FIG. 16 shows a communication diagram of a host communicating via a network node with a UE over a partially wireless connection in accordance with some embodiments.

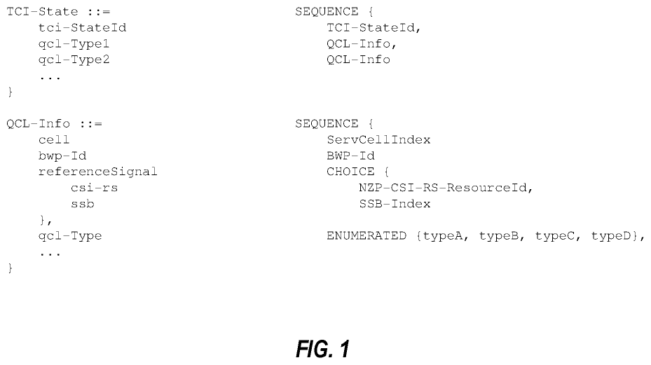

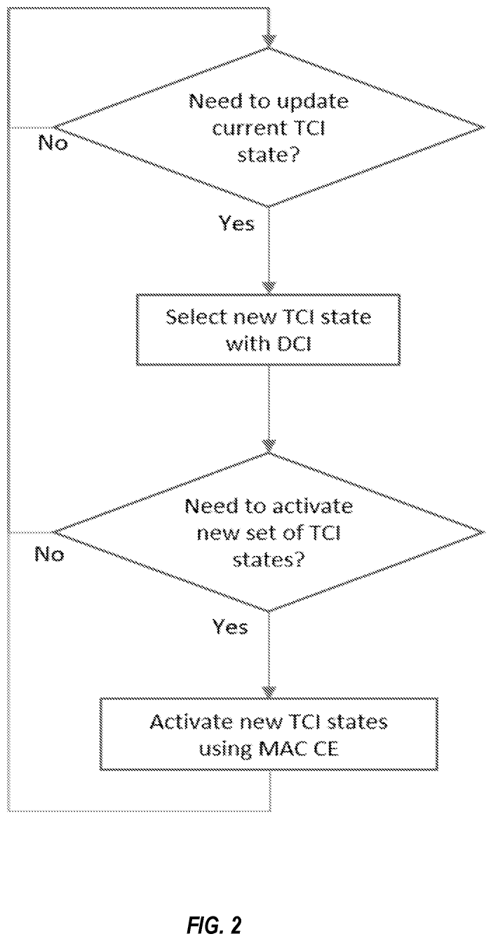

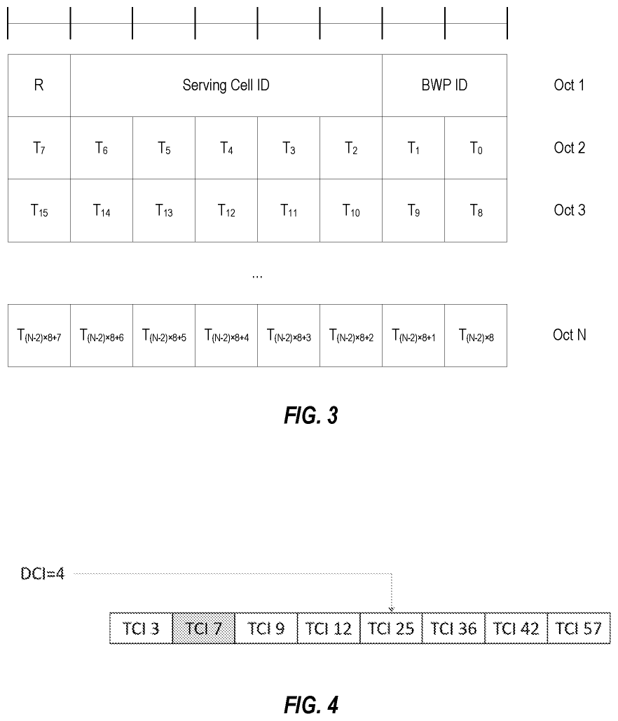

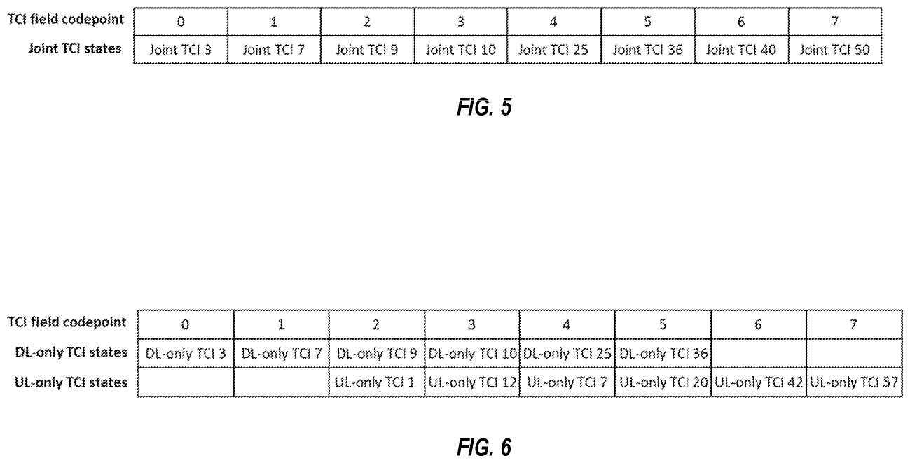

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). To support both “Joint DL/UL TCI” and “Separate DL/UL TCI” operations, a Medium Access Control (MAC) Control Element (CE) design is needed to map Joint Transmission Configuration Indication (TCI) states, downlink (DL) TCI states, and/or uplink (UL) TCI states to codepoints of the TCI field in Downlink Control Information (DCI). Furthermore, for “Separate DL/UL TCI” operation, the TCI state mapping needs to support the following as shown in the example of FIG. 6:
one or more codepoints in the TCI field of DCI is/are mapped to only one DL TCI state,
one or more codepoints in the TCI field of DCI is/are mapped to only one UL TCI state,
one or more codepoints in the TCI field of DCI is/are mapped to both one DL TCI state and one UL TCI state.

How to design such a MAC CE that supports both “Joint DL/UL TCI” and “Separate DL/UL TCI” operations while keeping the MAC CE overhead (i.e., number of Octets in the MAC CE) as low as possible is an open problem that needs to be solved.

Certain aspects of the disclosure and their embodiments may provide solutions to these or other challenges. Systems and methods are disclosed here for efficient MAC CE designs with low overhead are proposed for indicating TCI state to TCI field codepoint mapping for both “Joint DL/UL TCI” and “Separate DL/UL TCI” operations.

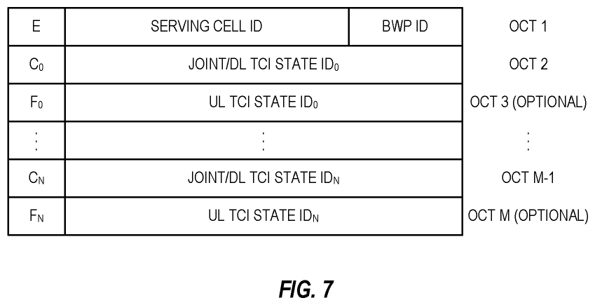

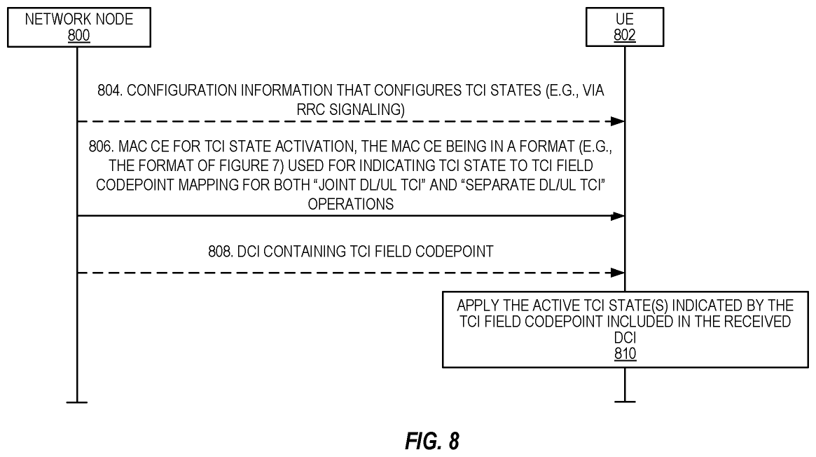

In accordance with one embodiment of the present disclosure, a first MAC CE design shown in FIG. 7 includes a first field in the MAC CE to differentiate whether joint DL/UL TCI states or separate DL/UL TCI states are mapped to the TCI field codepoints in DCI. In this MAC CE design, a second field is introduced for each TCI field codepoint in the DCI to indicate whether an UL TCI state is mapped to the corresponding TCI field codepoint in the DCI. Similarly, a third field is introduced for each TCI field codepoint in the DCI to indicate whether a DL TCI state is mapped to the corresponding TCI field codepoint in the DCI.

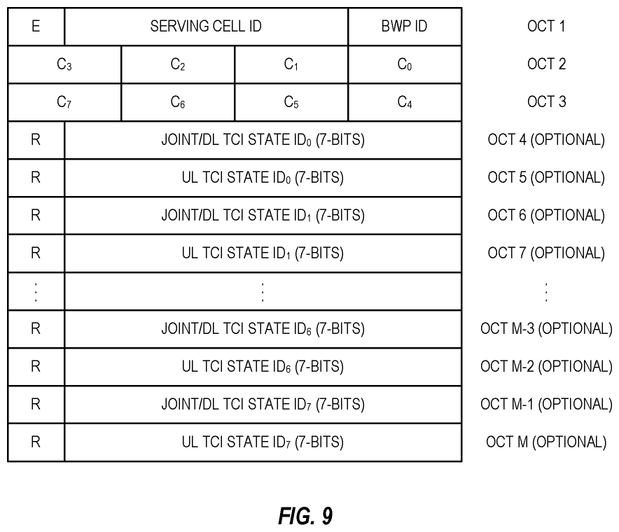

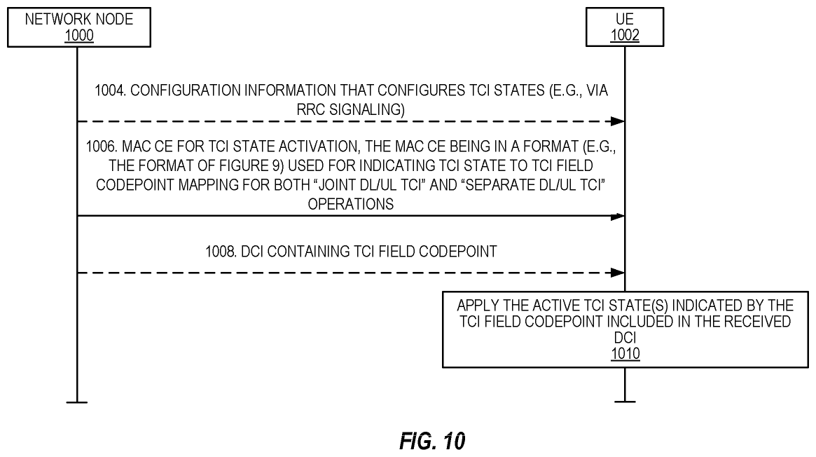

In one embodiment, a second MAC CE design shown in FIG. 9 includes a first field in the MAC CE to differentiate whether joint DL/UL TCI states or separate DL/UL TCI states are mapped to the TCI field codepoints in DCI. In this MAC CE design, a second field is introduced for each TCI field codepoint in the DCI to indicate which among the following TCI field mappings apply to the corresponding TCI field codepoint:
the TCI field codepoint is mapped to a DL only TCI state
the TCI field codepoint is mapped to an UL only TCI state
the TCI field codepoint is mapped to both a DL only TCI state and an UL only TCI state

Certain embodiments may provide one or more of the following technical advantage(s). The proposed solutions provide a low overhead approach to mapping TCI states to TCI field codepoints in a DCI. Some solutions proposed in the disclosure provide the possibility to indicate in a single MAC CE whether Joint DL/UL TCI states or Separate DL/UL TCI states are mapped to the TCI field codepoints in the DCI. In addition, for separate DL/UL TCI states, the proposed solutions enable low overhead mapping of a DL only TCI state, a UL only TCI state, or both a DL only TCI state and an UL only TCI state for each TCI field codepoint in the DCI.

Systems and methods are disclosed here for efficient MAC CE designs with low overhead are proposed for indicating TCI state to TCI field codepoint mapping for both “Joint DL/UL TCI” and “Separate DL/UL TCI” operations. In accordance with one embodiment of the present disclosure, a MAC CE for supporting both “Joint DL/UL TCI” and “Separate DL/UL TCI” operations is provided as illustrated in FIG. 7. In this MAC CE, the field ‘E’ indicates if the TCI states mapped to the TCI field codepoints are ‘Joint TCI states’ or ‘Separate DL/UL TCI states’.
If the field ‘E’ is set to a first value (e.g., ‘1’), then the TCI states mapped to the TCI field codepoints are ‘Joint TCI states’. In this case, the field ‘Joint/DL TCI state ID_{N}’ represents the ID of the joint TCI state which is mapped to the N^{th} codepoint in the TCI field in DCI. This means when the UE is indicated by the gNB with the N^{th} codepoint in the TCI field via a DCI (e.g., downlink DCI with formats 1_1 or 1_2), the UE should apply the joint TCI state given by “Joint/DL TCI state ID_{N}” as common QCL source for both DL and UL signals/channels. In addition, when the field ‘E’ is set to the first value (e.g., ‘1’), the octets containing the fields ‘UL TCI state ID₀’, . . . , ‘UL TCI state ID_{N}’ are not present in the MAC CE. That is, the MAC CE contains 8 octets containing IDs for ‘Joint TCI states’ for the TCI field codepoints in DCI.
If the field ‘E’ is set to a second value (e.g., ‘0’), then the TCI states mapped to the TCI field codepoints are ‘Separate DL/UL TCI states’. In this case, the field ‘C_{N}’ indicates if an octet with an UL TCI state is present. In case it is present, the UL TCI state is mapped to the N^{th} codepoint in the TCI field in DCI. In this case, the MAC CE contains 8-16 octets containing IDs for ‘DL TCI states’ and possibly “UL TCI states” for the TCI field codepoints in DCI.
   If the ‘C_{N}’ field indicates a first value (e.g., ‘1’), then an UL TCI state is present and is mapped to the N^{th} codepoint in the TCI field in DCI. This UL TCI state mapped to the N^{th} codepoint in the TCI field in DCI is represented by the ID given by the field ‘UL TCI state ID_{N}’. Whether the N^{th} codepoint in the TCI field in DCI is also mapped to a DL TCI state (in addition to the UL TCI state given by ‘UL TCI state ID_{N}’) is determined by the ‘F_{N}’ field.
      If the ‘F_{N}’ field indicates a first value (e.g., ‘1’), then a DL TCI state is also mapped to the N^{th} codepoint in the TCI field in DCI in addition to the UL TCI state given by ‘UL TCI state ID_{N}’. The DL TCI state mapped to the N^{th} codepoint in the TCI field in DCI is represented by the ID given by the field ‘Joint/DL TCI state ID_{N}’. Note here that the octet with DL TCI state needs to be present as there are no fields above it that can be used to indicate its presence. Thus, the ‘F_{N}’ field describes whether the UE considers the DL TCI state to be mapped to the N^{th} codepoint or not. In case, the DL TCI state is not mapped to the N^{th} codepoint, the UE considers those bits are padding bits.
      If the ‘F_{N}’ field indicates a second value (e.g., ‘0’), then a DL TCI state is not mapped to the N^{th} codepoint in the TCI field in DCI. In this case, the N^{th} codepoint in the TCI field in DCI is only mapped to the UL TCI state represented by the ID given by the field by ‘UL TCI state ID_{N}’. In this case, the bits in the field ‘Joint/DL TCI state ID_{N}’ are considered as padding bits by the UE (alternatively stated, the bits in the field ‘Joint/DL TCI state ID_{N}’ are ignored by the UE).
   If the ‘C_{N}’ field indicates a second value (e.g., ‘0’), then an UL TCI state is not mapped to the N^{th} codepoint in the TCI field in DCI. This means that octet containing the field ‘UL TCI state ID_{N}’ is not present in the MAC CE. In this case, only a DL TCI state is mapped to the N^{th} codepoint in the TCI field in DCI. The DL TCI state mapped to the N^{th} codepoint in the TCI field in DCI is represented by the ID given by the field ‘Joint/DL TCI state ID_{N}’.

In summary, the operation for the TCI mapping for the N^{th} codepoint in the TCI field in DCI for ‘Separate DL/UL TCI states’ when the field ‘E’ is set to the second value (e.g., ‘0’) is given as follows:
If ‘C_{N}’ field indicates the second value (e.g., ‘0’), then only a DL TCI state is mapped to the N^{th} codepoint in the TCI field in DCI. The DL TCI state mapped to the N^{th} codepoint in the TCI field in DCI is represented by the ID given by the field ‘Joint/DL TCI state ID_{N}’. This means when the UE is indicated by the gNB with the N^{th} codepoint in the TCI field via a DCI (e.g., downlink DCI with formats 1_1 or 1_2), the UE should apply the DL only TCI state given by “Joint/DL TCI state ID_{N}” as common QCL source for DL signals/channels.
If ‘C_{N}’ field indicates the first value (e.g., ‘1’) and if the ‘F_{N}’ field indicates the second value (e.g., ‘0’), then only an UL TCI state is mapped to the Nah codepoint in the TCI field in DCI. The UL TCI state mapped to the N^{th} codepoint in the TCI field in DCI is represented by the ID given by the field ‘UL TCI state ID_{N}’. This means when the UE is indicated by the gNB with the N^{th} codepoint in the TCI field via a DCI (e.g., downlink DCI with formats 1_1 or 1_2), the UE should apply the UL only TCI state given by “UL TCI state ID_{N}” as common QCL source for UL signals/channels.
If ‘C_{N}’ field indicates the first value (e.g., ‘1’) and if the ‘F_{N}’ field indicates the first value (e.g., ‘1’), then both a DL TCI state and an UL TCI state are mapped to the N^{th} codepoint in the TCI field in DCI. The DL TCI state mapped to the N^{th} codepoint in the TCI field in DCI is represented by the ID given by the field ‘Joint/DL TCI state ID_{N}’. The UL TCI state mapped to the N^{th} codepoint in the TCI field in DCI is represented by the ID given by the field ‘UL TCI state ID_{N}’. This means when the UE is indicated by the gNB with the N^{th} codepoint in the TCI field via a DCI (e.g., downlink DCI with formats 1_1 or 1_2), the UE should apply the DL only TCI state given by “Joint/DL TCI state ID_{N}” as common QCL source for DL signals/channels, and apply the UL only TCI state given by ‘UL TCI state ID_{N}’ as common QCL source for UL signals/channels.

FIG. 8 illustrates the operation of a network node 800 (e.g., a gNB or a network node that performs at least some of the functionality of a gNB such as, e.g., a gNB-DU or gNB-CU) and a UE 802 in accordance with at least some aspects of the embodiments described above with respect to FIG. 7. Optional steps are represented by dashed lines/boxes. As illustrated, network node 800 sends configuration information to the UE 802 (and the UE 802 receives the configuration information from the network node 800) via, e.g., RRC signaling, where the configuration information configures the UE 802 with a plurality of TCI states (step 804). The configured TCI states may include both joint DL/UL TCI states and separate DL/UL TCI states, as described above.

The network node 800 sends a MAC CE to the UE 802 (and the UE 802 receives the MAC CE from the network node 800) that activates one or more of the configured TCI states (step 806). The network node 800 may send a DCI to the UE 802 (and the UE 802 receives the DCI from the network node 800) that includes a TCI field set to one of a plurality of TCI field codepoints, where the TCI field codepoints are mapped to the activated TCI states via the MAC CE (step 808). The UE 802 may then apply the active TCI state(s) indicated by the TCI field codepoint included in the received DCI (step 810).

In a first embodiment, the MAC CE contains:
(a) a first field (i.e., E field) indicating whether the TCI states mapped to the TCI field codepoints in the DCI are joint DL/UL TCI states or separate DL/UL TCI states;
(b) a second field (i.e., C_{N} field) for each TCI field codepoint in the DCI indicating whether an UL TCI state is mapped to the corresponding TCI field codepoint in the DCI;
(c) a third field (i.e., F_{N} field) for each TCI field codepoint in the DCI indicating whether a DL TCI state is mapped to the corresponding TCI field codepoint in the DCI; or
(d) a combination of any two or more of (a)-(c).

In a second embodiment, the first field indicates a first value, and the TCI states mapped to all the TCI field codepoints in the DCI are ‘Joint TCI states’. In a third embodiment, the octets containing the UL TCI fields are absent in the MAC CE. In a fourth embodiment, in step 810, the UE 802 applies a joint TCI state mapped to the N^{th} codepoint in the TCI field of the DCI for both DL and UL signals/channels when the UE 802 is indicated by the network node 800 with the N^{th} codepoint in the TCI field via the DCI.

In a fifth embodiment, the first field indicates a second value, and the TCI states mapped to all the TCI field codepoints in the DCI are ‘Separate DL/UL TCI states’. In a sixth embodiment, the second field corresponding to the N^{th} codepoint in the TCI field of the DCI indicates a second value (e.g., ‘0’), and a DL only TCI state is mapped to the N^{th} codepoint in the TCI field in DCI. In seventh embodiment, the octet containing the UL TCI field corresponding to the N^{th} codepoint in the TCI field of the DCI is absent in the MAC CE. In an eighth embodiment, in step 810, the UE 802 applies the DL only TCI state mapped to the N^{th} codepoint in the TCI field of the DCI for DL signals/channels when the UE 802 is indicated by the network node 800 with the N^{th} codepoint in the TCI field via the DCI

In a ninth embodiment, the first field indicates a second value, the TCI states mapped to all the TCI field codepoints in the DCI are ‘Separate DL/UL TCI states’, the second field corresponding to the N^{th} codepoint in the TCI field of the DCI indicates a first value (e.g., ‘1’), the third field corresponding to the N^{th} codepoint in the TCI field of the DCI indicates a second value (e.g., ‘0’), and an UL only TCI state is mapped to the N^{th} codepoint in the TCI field in DCI. In a tenth embodiment, the octet containing the UL TCI field corresponding to the N^{th} codepoint in the TCI field of the DCI is present in the MAC CE. In an eleventh embodiment, the octet containing the DL TCI field corresponding to the N^{th} codepoint in the TCI field of the DCI is present in the MAC CE and is considered as padding bits by the UE 802.

In a twelfth embodiment, in step 810, the UE 802 applies the UL only TCI state mapped to the N^{th} codepoint in the TCI field of the DCI for UL signals/channels when the UE 802 is indicated by the network node 800 with the N^{th} codepoint in the TCI field via the DCI.

In a thirteenth embodiment, the first field indicates a second value, the TCI states mapped to all the TCI field codepoints in the DCI are ‘Separate DL/UL TCI states’, the second field corresponding to the N^{th} codepoint in the TCI field of the DCI indicates a first value (e.g., ‘1’), the third field corresponding to the N^{th} codepoint in the TCI field of the DCI indicates a first value (e.g., ‘1’), and both a DL TCI state and an UL only TCI state are mapped to the N^{th} codepoint in the TCI field in DCI. In a fourteenth embodiment, the octets containing the UL TCI field and the DL TCI field corresponding to the N^{th} codepoint in the TCI field of the DCI are both present in the MAC CE. In a fifteenth embodiment, in step 810, the UE 802 applies the UL only TCI state mapped to the N^{th} codepoint in the TCI field of the DCI for UL signals/channels when the UE 802 is indicated by the network node 800 with the N^{th} codepoint in the TCI field via the DCI. In a sixteenth embodiment, in step 810, the UE 802 applies the DL only TCI state mapped to the N^{th} codepoint in the TCI field of the DCI for DL signals/channels when the UE 802 is indicated by the network node 800 with the N^{th} codepoint in the TCI field via the DCI.

In an alternative embodiment, the E field is not used to indicate the type of the MAC CE (joint TCI states vs separate DL/UL TCI states) but separate MAC CEs are used for joint TCI state mapping to TCI field codepoints in DCI and for separate DL/UL TCI state mapping to TCI field codepoints in DCI. In this case, the separate MAC CE for separate DL/UL TCI state mapping to TCI field codepoints in DCI has the E field marking whether next octet is for DL TCI state or UL TCI state. If the value of E is “1”, the next octet is DL TCI state, and if the value is “0”, the next octet is UL TCI state. In the case E has value of “1” and the octet containing DL TCI state is present, this octet also contains C field. The C field works as in the above MAC CE and describes whether an octet containing UL TCI state is present nor not.

Another alternative MAC CE design is shown in FIG. 9. In this MAC CE, a two bit field C_{N} is included in the MAC CE for each TCI field codepoint N in DCI. In this alternative MAC CE, the field ‘E’ indicates if the TCI states mapped to the TCI field codepoints are ‘Joint TCI states’ or ‘Separate DL/UL TCI states’.
If the field ‘E’ is set to a first value (e.g., ‘1’), then the TCI states mapped to the TCI field codepoints are ‘Joint TCI states’. In this case, the field ‘Joint/DL TCI state ID_{N}’ represents the ID of the joint TCI state which is mapped to the N^{th} codepoint in the TCI field in DCI. This means when the UE is indicated by the gNB with the N^{th} codepoint in the TCI field via a DCI (e.g., downlink DCI with formats 1_1 or 1_2), the UE should apply the joint TCI state given by “Joint/DL TCI state ID_{N}” as common QCL source for both DL and UL signals/channels. In addition, when the field ‘E’ is set to the first value (e.g., ‘1’), the octets containing the fields ‘UL TCI state ID₀’, . . . , ‘UL TCI state ID₇’ are not present in the MAC CE. In some embodiments, when the field ‘E’ is set to the first value (e.g., ‘1’), the octets containing the fields ‘C_{N}’ are not present in the MAC CE.
If the field ‘E’ is set to a second value (e.g., ‘0’), then the TCI states mapped to the TCI field codepoints are ‘Separate DL/UL TCI states’. In this case, the field ‘C_{N}’ indicates the TCI state mapping to the N^{th} codepoint in the TCI field in DCI as follows:
   If ‘C_{N}’ field indicates a first value (e.g., ‘00’), then only a DL TCI state is mapped to the N^{th} codepoint in the TCI field in DCI. The DL TCI state mapped to the N^{th} codepoint in the TCI field in DCI is represented by the ID given by the field ‘Joint/DL TCI state ID_{N}’. This means when the UE is indicated by the gNB with the N^{th} codepoint in the TCI field via a DCI (e.g., downlink DCI with formats 1_1 or 1_2), the UE should apply the DL only TCI state given by “Joint/DL TCI state ID_{N}” as common QCL source for DL signals/channels. When the ‘C_{N}’ field indicates the first value (e.g., ‘00’), the octet providing the field ‘Joint/DL TCI state ID_{N}’ is present in the MAC CE, and the octet with the field ‘UL TCI state ID_{N}’ is absent from the MAC CE.
   If ‘C_{N}’ field indicates a second value (e.g., ‘01’), then only a UL TCI state is mapped to the N^{th} codepoint in the TCI field in DCI. The UL TCI state mapped to the N^{th} codepoint in the TCI field in DCI is represented by the ID given by the field ‘UL TCI state ID_{N}’. This means when the UE is indicated by the gNB with the N^{th} codepoint in the TCI field via a DCI (e.g., downlink DCI with formats 1_1 or 1_2), the UE should apply the UL only TCI state given by “UL TCI state ID_{N}” as common QCL source for UL signals/channels. When the ‘C_{N}’ field indicates the second value (e.g., ‘01’), the octet providing the field ‘UL TCI state ID_{N}’ is present in the MAC CE, and the octet with the field ‘Joint/DL TCI state ID_{N}’ is absent from the MAC CE.
   If ‘C_{N}’ field indicates a third value (e.g., ‘10’), then both a DL TCI state and an UL TCI state are mapped to the N^{th} codepoint in the TCI field in DCI. The DL TCI state mapped to the N^{th} codepoint in the TCI field in DCI is represented by the ID given by the field ‘Joint/DL TCI state ID_{N}’. The UL TCI state mapped to the N^{th} codepoint in the TCI field in DCI is represented by the ID given by the field ‘UL TCI state ID_{N}’. This means when the UE is indicated by the gNB with the N^{th} codepoint in the TCI field via a DCI (e.g., downlink DCI with formats 1_1 or 1_2), the UE should apply the DL only TCI state given by “Joint/DL TCI state ID_{N}” as common QCL source for DL signals/channels, and apply the UL only TCI state given by ‘UL TCI state ID_{N}’ as common QCL source for UL signals/channels. When the ‘C_{N}’ field indicates the third value (e.g., ‘10’), the octets providing the fields ‘UL TCI state ID_{N}’ and ‘Joint/DL TCI state ID_{N}’ are both present in the MAC CE.

In this MAC CE design, one value of the ‘C_{N}’ field (e.g., ‘11’) may be reserved or used to indicate no TCI states are mapped to the N^{th} codepoint in the TCI field.

FIG. 10 illustrates the operation of a network node 1000 (e.g., a gNB or a network node that performs at least some of the functionality of a gNB such as, e.g., a gNB-DU or gNB-CU) and a UE 1002 in accordance with at least some aspects of the embodiments described above with respect to FIG. 9. Optional steps are represented by dashed lines/boxes. As illustrated, network node 1000 sends configuration information to the UE 1002 (and the UE 1002 receives the configuration information from the network node 1000) via, e.g., RRC signaling, where the configuration information configures the UE 1002 with a plurality of TCI states (step 1004). The configured TCI states may include both joint DL/UL TCI states and separate DL/UL TCI states, as described above.

The network node 1000 sends a MAC CE to the UE 1002 (and the UE 1002 receives the MAC CE from the network node 1000) that activates one or more of the configured TCI states (step 1006). The MAC CE of this embodiment is in accordance with the embodiments described above with respect to FIG. 9. The network node 1000 may send a DCI to the UE 1002 (and the UE 1002 receives the DCI from the network node 1000) that includes a TCI field set to one of a plurality of TCI field codepoints, where the TCI field codepoints are mapped to the activated TCI states via the MAC CE (step 1008). The UE 1002 may then apply the active TCI state(s) indicated by the TCI field codepoint included in the received DCI (step 1010).

As illustrated in FIG. 9, the MAC CE of step 1006 includes a first field (i.e., the E field) that indicates whether the TCI states mapped to the TCI field codepoints are Joint DL/UL TCI states or Separate DL/UL TCI States. Further details regarding the first field (i.e., the E field) are provided above and equally applicable here. The MAC CE may also include a set of second fields (i.e., the set of C_{N} fields) that, when the first field is set to a second value (e.g., ‘0’) that indicates that the TCI states mapped to the TCI field codepoints are Separate DL/UL TCI states, indicate whether the respective TCI field codepoint in DCI is mapped to the respective DL TCI state, the respective UL TCI state, or both the respective DL TCI state and the respective UL TCI state in the MAC CE. Further details regarding this are provided above and equally applicable here.

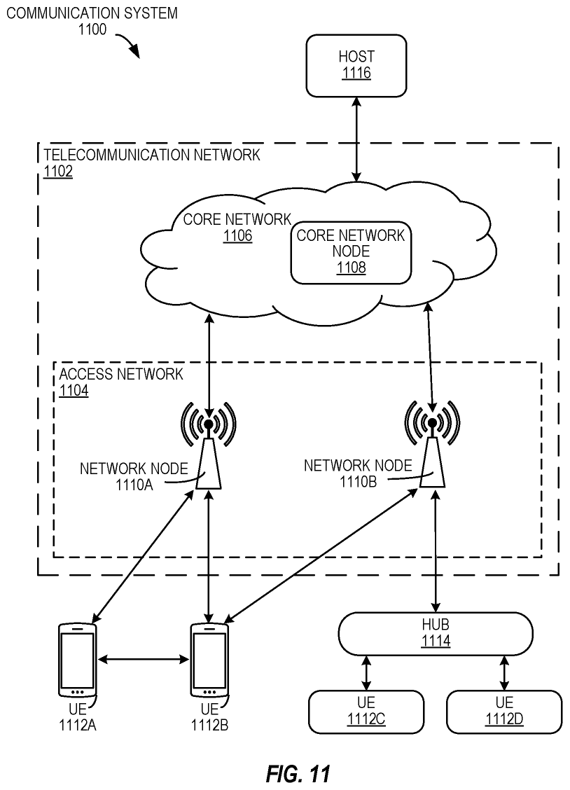

FIG. 11 shows an example of a communication system 1100 in accordance with some embodiments.

In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102 and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system 1100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110B. In other embodiments, the hub 1114 may be a non-dedicated hub—that is, a device which is capable of operating to route communications between the UEs and the network node 1110B, but which is additionally capable of operating as a communication start and/or end point for certain data channels.

FIG. 12 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

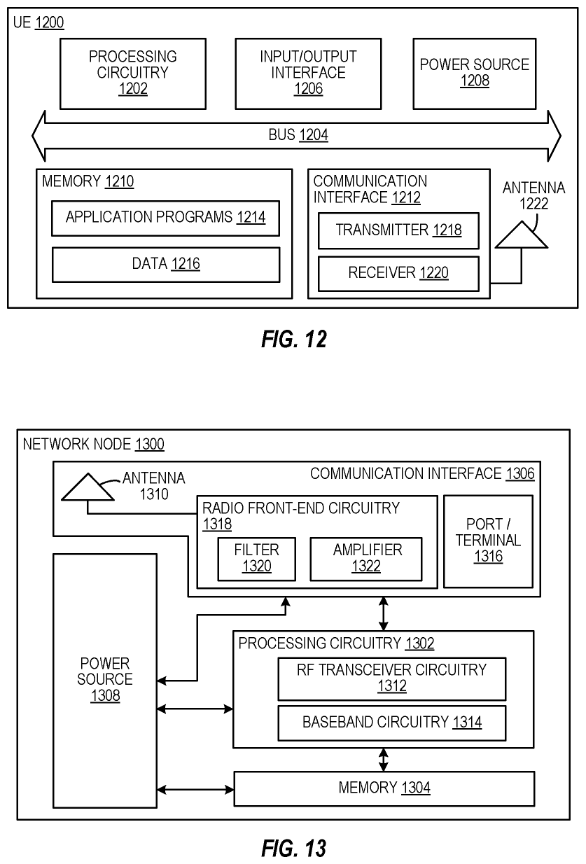

FIG. 13 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

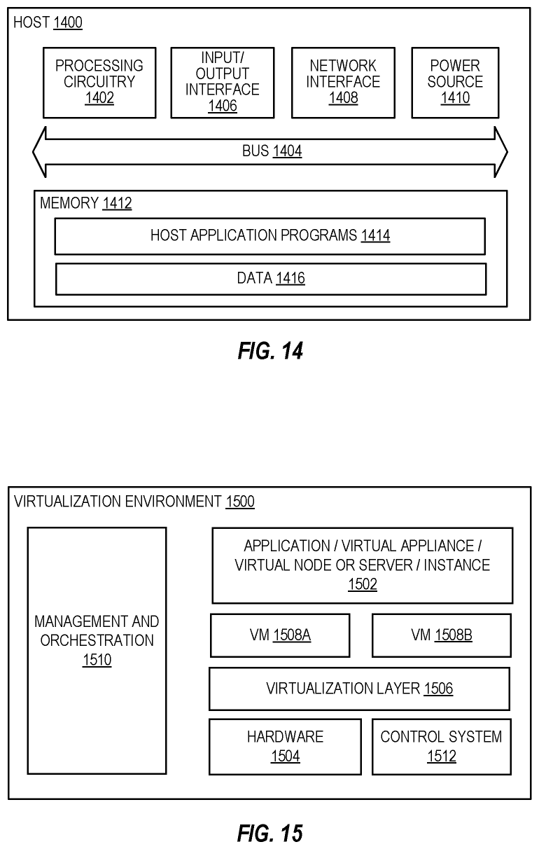

FIG. 14 is a block diagram of a host 1400, which may be an embodiment of the host 1116 of FIG. 11, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 12 and 13, such that the descriptions thereof are generally applicable to the corresponding components of the host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506. Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

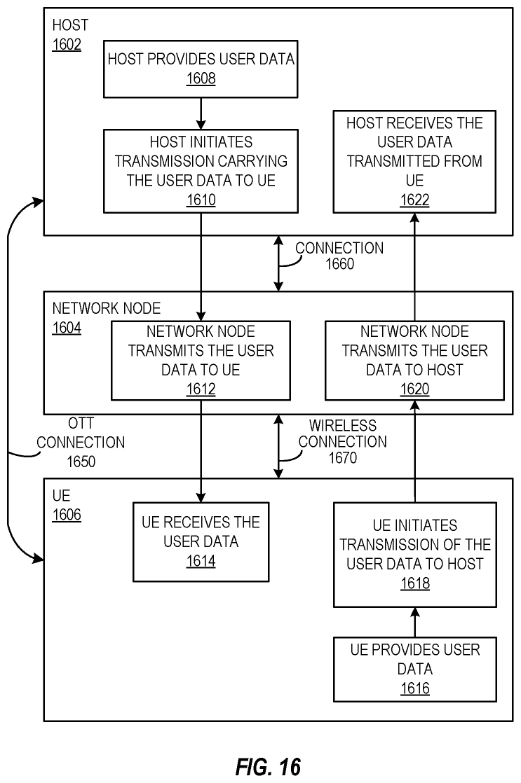

FIG. 16 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 11 and/or the UE 1200 of FIG. 12), the network node (such as the network node 1110A of FIG. 11 and/or the network node 1300 of FIG. 13), and the host (such as the host 1116 of FIG. 11 and/or the host 1400 of FIG. 14) discussed in the preceding paragraphs will now be described with reference to FIG. 16.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some example embodiments of the present disclosure are as follows:

### Group A Embodiments

Embodiment 1: A method performed by a User Equipment, UE, (802) for mapping TCI states to TCI field codepoints in a DCI, the method comprising:
receiving (806) a MAC CE message from a network node (800); and
receiving (808) a DCI from the network node (800), the DCI comprising a TCI field set to one of a plurality of TCI field codepoints;
wherein the MAC CE maps TCI states to at least some of the plurality of TCI field codepoints and the MAC CE comprises:
   (a) a first field that indicates whether the TCI states mapped to the TCI field codepoints are joint DL/UL TCI states or separate DL/UL TCI states;
   (b) a second field for each TCI field codepoint that indicates whether an UL TCI state is mapped to the corresponding TCI field codepoint in the DCI;
   (c) a third field for each TCI field codepoint that indicates whether a DL TCI state is mapped to the corresponding TCI field codepoint.

Embodiment 2: The method of embodiment 1, wherein the MAC CE comprises the first field, and the first field indicates a first value, the TCI states mapped to all the TCI field codepoints in the DCI are joint DL/UL TCI states.

Embodiment 3: The method of embodiment 2, wherein octets containing UL TCI fields are absent in the MAC CE.

Embodiment 4: The method of any of embodiments 1 to 3, further comprising applying (810) a joint TCI state mapped to the N^{th} codepoint in the TCI field of the DCI for both DL and UL signals/channels when the UE (802) is indicated by the network node (800) with the N^{th} codepoint in the TCI field via the DCI.

Embodiment 5: The method of embodiment 1, wherein the MAC CE comprises the first field, the first field indicates a second value, and the TCI states mapped to all the TCI field codepoints in the DCI are Separate DL/UL TCI states.

Embodiment 6: The method of embodiment 5, wherein the MAC CE further comprises the second field for each TCI field codepoint, the second field corresponding to the N^{th} codepoint in the TCI field of the DCI indicates a second value (e.g., ‘0’), and a DL only TCI state is mapped to the N^{th} codepoint in the TCI field in DCI.

Embodiment 7: The method of embodiment 6, wherein an octet containing the UL TCI field corresponding to the N^{th} codepoint in the TCI field of the DCI is absent in the MAC CE.

Embodiment 8: The method of any of embodiments 1 and 5 to 7, further comprising applying (810) the DL only TCI state mapped to the N^{th} codepoint in the TCI field of the DCI for DL signals/channels when the UE (802) is indicated by the network node (800) with the N^{th} codepoint in the TCI field via the DCI.

Embodiment 9: The method of embodiment 5, wherein:
the MAC CE further comprises the second field for each TCI field codepoint and the third field for each TCI field codepoint;
the second field corresponding to the N^{th} codepoint in the TCI field of the DCI indicates a first value (e.g., ‘1’);
the third field corresponding to the N^{th} codepoint in the TCI field of the DCI indicates a second value (e.g., ‘0’); and
an UL only TCI state is mapped to the N^{th} codepoint in the TCI field in DCI.

Embodiment 10: The method of embodiment 9, wherein an octet containing the UL TCI field corresponding to the N^{th} codepoint in the TCI field of the DCI is present in the MAC CE.

Embodiment 11: The method of embodiment 9, wherein an octet containing the DL TCI field corresponding to the N^{th} codepoint in the TCI field of the DCI is present in the MAC CE and is considered as padding bits by the UE (800).

Embodiment 12: The method of any of embodiments 5 and 9 to 11, further comprising applying (810) the UL only TCI state mapped to the N^{th} codepoint in the TCI field of the DCI for UL signals/channels when the UE (802) is indicated by the network node (800) with the N^{th} codepoint in the TCI field via the DCI.

Embodiment 13: The method of embodiment 5, wherein:
the MAC CE further comprises the second field for each TCI field codepoint and the third field for each TCI field codepoint;
the second field corresponding to the N^{th} codepoint in the TCI field of the DCI indicates a first value (e.g., ‘1’);
the third field corresponding to the N^{th} codepoint in the TCI field of the DCI indicates a first value (e.g., ‘1’); and
both a DL TCI state and an UL only TCI state are mapped to the N^{th} codepoint in the TCI field in DCI.

Embodiment 14: The method of embodiment 13, wherein octets containing the UL TCI field and the DL TCI field corresponding to the N^{th} codepoint in the TCI field of the DCI are both present in the MAC CE.

Embodiment 15: The method of any of embodiments 5, 13, and 14, further comprising applying (810) the UL only TCI state mapped to the N^{th} codepoint in the TCI field of the DCI for UL signals/channels when the UE (802) is indicated by the network node (800) with the N^{th} codepoint in the TCI field via the DCI.

Embodiment 16: The method of any of embodiments 5, 13, and 14, further comprising applying (810) the DL only TCI state mapped to the N^{th} codepoint in the TCI field of the DCI for DL signals/channels when the UE (800) is indicated by the network node (800) with the N^{th} codepoint in the TCI field via the DCI.

Embodiment 17: A method performed by a User Equipment, UE, (1002) for mapping TCI states to TCI field codepoints in a DCI, the method comprising:
receiving (1006) a MAC CE message from a network node (1000); and
receiving (1008) a DCI from the network node (1000), the DCI comprising a TCI field set to one of a plurality of TCI field codepoints;
wherein the MAC CE maps TCI states to at least some of the plurality of TCI field codepoints and the MAC CE comprises:
   (a) a first field that indicates whether the TCI states mapped to the TCI field codepoints are joint DL/UL TCI states or separate DL/UL TCI states;
   (b) a set of second fields that indicate whether respective TCI field codepoints are mapped to respective DL TCI states indicated in the MAC CE, respective UL TCI states indicated in the MAC CE, or both the respective DL TCI states indicated in the MAC CE and the respective UL TCI states indicated in the MAC CE; or
   (c) both (a) and (b).

Embodiment 18: The method of embodiment 17 wherein the MAC CE is further in accordance with any of the aspects or embodiments described herein, e.g., with respect to FIG. 9.

Embodiment 19: The method of any of the previous embodiments, further comprising:
providing user data; and
forwarding the user data to a host via the transmission to the network node.

### Group B Embodiments

Embodiment 20: A method performed by a network node (800) for mapping TCI states to TCI field codepoints in a DCI, the method comprising:
transmitting (806) a MAC CE message to a UE (802); and
transmitting (808) a DCI to the UE (802), the DCI comprising a TCI field set to one of a plurality of TCI field codepoints;
wherein the MAC CE maps TCI states to at least some of the plurality of TCI field codepoints and the MAC CE comprises:
   (a) a first field that indicates whether the TCI states mapped to the TCI field codepoints are joint DL/UL TCI states or separate DL/UL TCI states;
   (b) a second field for each TCI field codepoint that indicates whether an UL TCI state is mapped to the corresponding TCI field codepoint in the DCI;
   (c) a third field for each TCI field codepoint that indicates whether a DL TCI state is mapped to the corresponding TCI field codepoint.

Embodiment 21: A method performed by a network node (1000) for mapping TCI states to TCI field codepoints in a DCI, the method comprising:
transmitting (1006) a MAC CE message to a UE (1002); and
transmitting (1008) a DCI to the UE (802), the DCI comprising a TCI field set to one of a plurality of TCI field codepoints;
wherein the MAC CE maps TCI states to at least some of the plurality of TCI field codepoints and the MAC CE comprises:
   (a) a first field that indicates whether the TCI states mapped to the TCI field codepoints are joint DL/UL TCI states or separate DL/UL TCI states;
   (b) a set of second fields that indicate whether respective TCI field codepoints are mapped to respective DL TCI states indicated in the MAC CE, respective UL TCI states indicated in the MAC CE, or both the respective DL TCI states indicated in the MAC CE and the respective UL TCI states indicated in the MAC CE; or
   (c) both (a) and (b).

Embodiment 22: The method of any of the previous embodiments, further comprising:
obtaining user data; and
forwarding the user data to a host or a user equipment.

### Group C Embodiments

Embodiment 23: A user equipment comprising:
processing circuitry configured to perform any of the steps of any of the Group A embodiments; and
power supply circuitry configured to supply power to the processing circuitry.

Embodiment 24: A network node comprising:
processing circuitry configured to perform any of the steps of any of the Group B embodiments;
power supply circuitry configured to supply power to the processing circuitry.

Embodiment 25: A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 26: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

Embodiment 27: The host of the previous embodiment, wherein the cellular network further includes a network node configured to communicate with the UE to transmit the user data to the UE from the host.

Embodiment 28: The host of the previous 2 embodiments, wherein:
the processing circuitry of the host is configured to execute a host application, thereby providing the user data; and
the host application is configured to interact with a client application executing on the UE, the client application being associated with the host application.

Embodiment 29: A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Embodiment 30: The method of the previous embodiment, further comprising:
at the host, executing a host application associated with a client application executing on the UE to receive the user data from the UE.

Embodiment 31: The method of the previous embodiment, further comprising:
at the host, transmitting input data to the client application executing on the UE, the input data being provided by executing the host application,
wherein the user data is provided by the client application in response to the input data from the host application.

Embodiment 32: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

Embodiment 33: The host of the previous embodiment, wherein the cellular network further includes a network node configured to communicate with the UE to transmit the user data from the UE to the host.

Embodiment 34: The host of the previous 2 embodiments, wherein:
the processing circuitry of the host is configured to execute a host application, thereby providing the user data; and
the host application is configured to interact with a client application executing on the UE, the client application being associated with the host application.

Embodiment 35: A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

Embodiment 36: The method of the previous embodiment, further comprising:
at the host, executing a host application associated with a client application executing on the UE to receive the user data from the UE.

Embodiment 37: The method of the previous embodiment, further comprising:
at the host, transmitting input data to the client application executing on the UE, the input data being provided by executing the host application,
wherein the user data is provided by the client application in response to the input data from the host application.

Embodiment 38: A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 39: The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 40: A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

Embodiment 41: The method of the previous embodiment, further comprising, at the network node, transmitting the user data provided by the host for the UE.

Embodiment 42: The method of any of the previous 2 embodiments, wherein the user data is provided at the host by executing a host application that interacts with a client application executing on the UE, the client application being associated with the host application.

Embodiment 43: A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 44: The communication system of the previous embodiment, further comprising:
the network node; and/or
the user equipment.

Embodiment 45: A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 46: The host of the previous 2 embodiments, wherein:
the processing circuitry of the host is configured to execute a host application, thereby providing the user data; and
the host application is configured to interact with a client application executing on the UE, the client application being associated with the host application.

Embodiment 47: The host of the any of the previous 2 embodiments, wherein the initiating receipt of the user data comprises requesting the user data.

Embodiment 48: A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

Embodiment 49: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, for mapping Transmission Configuration Indication, TCI, states to TCI field codepoints in a Downlink Control information, DCI, the method comprising:
receiving a Medium Access Control, MAC, Control Element, CE, message from a network node; and
receiving a DCI from the network node, the DCI comprising a TCI field set to one of a plurality of TCI field codepoints;
wherein:
the MAC CE maps TCI states to at least some of the plurality of TCI field codepoints;
the MAC CE comprises a first field that indicates whether a first TCI state indicated by the MAC CE that is mapped to a first TCI field codepoint in the DCI is a downlink, DL, TCI state or an uplink, UL, TCI state; and
the MAC CE comprises a second field that indicates whether the MAC CE further indicates whether the first TCI field codepoint indicates one or multiple TCI states, and wherein in response to the second field indicating multiple TCI states, the first TCI field codepoint indicates both a DL TCI state and an UL TCI state.

2. The method of claim 1, wherein the first field indicates that the first TCI state indicated by the MAC CE that is mapped to the first TCI field codepoint in the DCI is a DL TCI state.

3. The method of claim 2, wherein the MAC CE further comprises:
a second field that indicates whether the MAC CE further indicates an UL TCI state mapped to the first TCI field codepoint in the DCI.

4. The method of claim 3, wherein the information that indicates whether a DL TCI state, UL TCI state, or both a DL TCI state and an UL TCI state are indicated for the first TCI field codepoint comprises the first field and the second field.

5. (canceled)

6. The method of claim 2, wherein the one of the plurality of TCI field codepoints to which the TCI field in the DCI is set is the first TCI field codepoint, and the method further comprises applying the DL TCI state mapped to the first codepoint of the TCI field of the DCI for DL signals and/or channels.

7. The method of claim 1, wherein the first field indicates that the first TCI state indicated by the MAC CE that is mapped to the first TCI field codepoint in the DCI is an UL TCI state.

8. The method of claim 7, wherein the one of the plurality of TCI field codepoints to which the TCI field in the DCI is set is the first TCI field codepoint, and the method further comprises applying the UL TCI state mapped to the first codepoint of the TCI field of the DCI for UL signals and/or channels.

9. The method of claim 1, wherein the MAC CE is in accordance with a MAC CE format for activation of separate DL and UL TCI states.

10. A User Equipment, UE, for mapping Transmission Configuration Indication, TCI, states to TCI field codepoints in a Downlink Control information, DCI, the UE adapted to:
receive a Medium Access Control, MAC, Control Element, CE, message from a network node; and
receive a DCI from the network node, the DCI comprising a TCI field set to one of a plurality of TCI field codepoints;
wherein:
the MAC CE maps TCI states to at least some of the plurality of TCI field codepoints;
the MAC CE comprises a first field that indicates whether a first TCI state indicated by the MAC CE that is mapped to a first TCI field codepoint in the DCI is a downlink, DL, TCI state or an uplink, UL, TCI state; and
a second field that indicates whether the MAC CE further indicates whether the first TCI field codepoint indicates one or multiple TCI states, and wherein in response to the second field indicating multiple TCI states, the first TCI field codepoint indicates both a DL TCI state and an UL TCI state.

11. (canceled)

12. A User Equipment, UE, for mapping Transmission Configuration Indication, TCI, states to TCI field codepoints in a Downlink Control information, DCI, the UE comprising:
one or more transmitters;
one or more receivers; and
processing circuitry associated with the one or more transmitters and the one or more receivers, the processing circuitry configured to cause the UE to:
receive a Medium Access Control, MAC, Control Element, CE, message from a network node; and
receive a DCI from the network node, the DCI comprising a TCI field set to one of a plurality of TCI field codepoints;
wherein:
the MAC CE maps TCI states to at least some of the plurality of TCI field codepoints;
the MAC CE comprises a first field that indicates whether a first TCI state indicated by the MAC CE that is mapped to a first TCI field codepoint in the DCI is a downlink, DL, TCI state or an uplink, UL, TCI state; and
the MAC CE comprises a second field that indicates whether the MAC CE further indicates whether the first TCI field codepoint indicates one or multiple TCI states, and wherein in response to the second field indicating multiple TCI states, the first TCI field codepoint indicates both a DL TCI state and an UL TCI state.

13. The UE of claim 12, wherein the first field indicates that the first TCI state indicated by the MAC CE that is mapped to the first TCI field codepoint in the DCI is a DL TCI state.

14. The UE of claim 13, wherein the MAC CE further comprises:
a second field that indicates whether the MAC CE further indicates an UL TCI state mapped to the first TCI field codepoint in the DCI.

15. The UE of claim 14, wherein the information that indicates whether a DL TCI state, UL TCI state, or both a DL TCI state and an UL TCI state are indicated for the first TCI field codepoint comprises the first field and the second field.

16. (canceled)

17. The UE of claim 13, wherein the one of the plurality of TCI field codepoints to which the TCI field in the DCI is set is the first TCI field codepoint, and the processing circuitry is further configured to cause the UE to apply the DL TCI state mapped to the first codepoint of the TCI field of the DCI for DL signals and/or channels.

18. The UE of claim 12, wherein the first field indicates that the first TCI state indicated by the MAC CE that is mapped to the first TCI field codepoint in the DCI is an UL TCI state.

19. The UE of claim 18, wherein the one of the plurality of TCI field codepoints to which the TCI field in the DCI is set is the first TCI field codepoint, and the processing circuitry is further configured to cause the UE to apply the UL TCI state mapped to the first codepoint of the TCI field of the DCI for UL signals and/or channels.

20. The UE of claim 12, wherein the MAC CE is in accordance with a MAC CE format for activation of separate DL and UL TCI states.
